(19) United States
(12) Patent Application Publication
(10) Pub. No.: US 2013/0106073 A1
(43) Pub. Date: May 2, 2013

(54) GAS CYLINDER CART

(71) Applicant: Praxair Technology, Inc., Danbury, CT (US)

(72) Inventors: Stephan GAMARD, Clarence, NY (US); Gerald C. SQUIRES, Clarence Center, NY (US); Julia BEHM, Port Washington, WI (US); Mark COLLINS, Fredonia, WI (US); Dwayne BECKMANN, Kiel, WI (US)

(73) Assignee: Praxair Technology, Inc., Danbury, CT (US)

(21) Appl. No.: 13/644,595

(22) Filed: Oct. 4, 2012

Related U.S. Application Data
(60) Provisional application No. 61/554,684, filed on Nov. 2, 2011.

(51) Int. Cl. B62B 3/02

(52) U.S. Cl. 280/79.2

(57) ABSTRACT

A portable medical gas cylinder cart is disclosed. The portable medical gas cylinder cart comprises: (i) a moveable base having a forward section and an back section, the moveable base being supported above ground level with a plurality of wheels, casters or other moveable support structures; (ii) a front panel attached to the moveable base proximate the forward section that extends vertically upward from the base to hide the gas cylinders from view; (iii) a main body attached to the back section of the moveable base; and (iv) one or more adjustable gas cylinder shelves connected to the main body and adapted to hold one or more gas cylinders in a vertical upright orientation behind the front panel. Each of the adjustable gas cylinder shelves includes a cylinder platform, housing, and retention strap or belt as well as a lift mechanism or jack that is adapted to raise or lower the cylinder platform to and from the ground level below the base of the cart to facilitate loading and unloading of the gas cylinders onto the cylinder platform.

### CROSS REFERENCE TO RELATED APPLICATIONS

The present application claims priority to and the benefit of U.S. provisional patent application Ser. No. 61/554684 filed Nov. 2, 2011.

### FIELD OF THE INVENTION

The present invention relates to a gas cylinder cart, more particularly, to a medical gas cylinder cart adapted for easy handling, transport and use of large gas cylinders.

### BACKGROUND

Medical gas cylinder carts are typically used to provide access to various gases such as oxygen, heliox, medical air, nitric oxide, etc. at locations proximate to the patient requiring the medical gas therapy. Typically, such medical gas cylinder carts are configured to hold one or more cylinders of medical gas. Often, various delivery devices, pressure gauges, regulators and valves are operably connected to the cylinder to allow the operator or respiratory therapist to control the flow of medical gas from the cylinder to the patient.

As shown in FIGS. 1A and 1B, typical medical gas cylinder carts for large heavy cylinders are dolly-type hand carts where the medical gas cylinders are placed on the base of the hand cart and transported patient by tilting the hand cart and rolling it to the desired location where the cylinder is usually chained to a nearby wall. While the dolly-type hand carts are relatively inexpensive and make it easy to add or remove the medical gas cylinders, there is the risk of injuring the personnel transporting the cart particularly where large and heavy medical gas cylinders are used. In many applications, large medical gas cylinders can weigh several hundreds of pounds. In addition, because of the need to tilt the medical gas cylinder during loading, transport and off-loading, there is the additional risk of the medical gas cylinders falling and injuring nearby personnel. Also, the dolly-type hand carts and means for affixing the medical gas cylinders to the nearby wall are not very aesthetic or visually appealing in a hospital or medical facility setting.

As shown in FIG. 1B, when the medical gas cylinders are delivered to the desired location (e.g. for use or storage), they are often chained or otherwise affixed to the wall to prevent accidental tipping of the medical gas cylinder. Such arrangement has the further disadvantage of fixing the location of the medical gas cylinders within the room or location prohibiting minor location adjustments of the medical gas cylinders when not in use or when additional space is needed in the room or requires the necessary infrastructure (i.e. chain, wall anchors) to be in place at the desired location for use. Also, when the medical gas cylinder requires replacement, the time and space needed for replacement is significant. In practice, the hospital or medical facility staff is often required to disconnect the patient from the medical gas cylinder; release the empty medical gas cylinder from the wall; remove the empty medical gas cylinder from the location using the hand cart; deliver a replacement cylinder with the hand cart; and affix the replacement medical gas cylinder to the wall and reconnect the replacement medical gas cylinder to the patient.

Yet another disadvantage of using the dolly-type hand carts is that it is often difficult to transport large medical gas cylinders and it is not practical to safely use the medical gas cylinders and deliver medical gas to the patient during transportation of the medical gas cylinder.

Other types of medical gas cylinder carts used for storage and transportation of medical gas cylinders is typified in United States Patent Application No. 2009/0121592. These types of medical gas cylinder carts are typically for emergency back-up supply of medical gases that are used in an easy to transport fashion. However, the medical gas cylinder carts disclosed in United States Patent Application No. 2009/0121592 are typically designed for small portable cylinders that must be manually lifted and loaded into the cart platform that is located several inches above the ground in order to provide enough clearance to wheel the cart. Most of these emergency back-up type of medical gas cylinder carts are not suitable for everyday use in hospitals and other medical facilities that use large, heavy cylinders that may weigh several hundreds of pounds. In addition, since many of the existing medical gas cylinder carts are designed for use as emergency gas back-up supply systems tend to have a large footprint since the objective is to transport and store as many cylinders as possible. The large footprint of many prior art gas cylinder carts is a serious disadvantage and hindrance in the reduced space of a typical hospital room.

The presently disclosed embodiments of medical gas cylinder cart overcomes the above-identified disadvantages associated with the prior art gas cylinder carts as described in more detailed description and drawings presented herein.

### SUMMARY OF THE INVENTION

The present invention may be characterized as a gas cylinder cart comprising: (i) a base supported above ground level with wheels, casters or other moveable support structures; (ii) a main body extending vertically from the base; (iii) one or more adjustable gas cylinder shelves connected to the main body and adapted to hold one or more gas cylinders in a vertical upright orientation; and (iv) a lift mechanism or jack coupled to the main body and configured to raise or lower the adjustable gas cylinder shelves to and from the ground level below the base to facilitate loading and unloading of the one or more gas cylinders onto the adjustable gas cylinder shelves.

The present invention may also be characterized as a gas cylinder cart comprising: (i) a moveable base having a forward section and an back section, the base being supported above ground level with wheels, casters or other moveable support structures; (ii) a front panel attached to the moveable base proximate the forward section of the moveable base and that extends vertically upward from the moveable base; (iii) a main body attached to the back section of the moveable base; and (iv) one or more adjustable gas cylinder shelves connected to the main body and adapted to hold one or more gas cylinders in a vertical upright orientation behind the front panel. Each of the adjustable gas cylinder shelves includes a cylinder platform, housing, and retention strap or belt as well as a lift mechanism or jack adapted to raise or lower the cylinder platform to and from the ground level below the base of the cart to facilitate loading and unloading of the gas cylinders onto the cylinder platform.

The present invention may further be characterized as a method of transporting one or more gas cylinders, comprising the steps of: (a) moving a gas cylinder cart to a first location proximate one or more gas cylinders, the gas cylinder cart comprising a base substantially parallel to a ground level; a main body; one or more adjustable gas cylinder shelves connected to the main body and adapted to hold one or more gas cylinders in a vertical upright orientation; and an actuated lift mechanism or jack coupled to the main body and configured to raise or lower the adjustable gas cylinder shelves; (b) lowering the one or more adjustable gas cylinder shelves on the gas cylinder cart to a position proximate the ground level using the actuated lift mechanism or jack; (c) loading one or more gas cylinders onto the lowered adjustable gas cylinder shelves; (d) raising the one or more adjustable gas cylinder shelves with the gas cylinders disposed thereon to a position above ground level using the actuated lift mechanism or jack; and (e) transporting the gas cylinder cart with one or more gas cylinders disposed in the one or more adjustable gas cylinder shelves positioned above ground level to a second location where the one or more gas cylinders are to be used.

### BRIEF DESCRIPTION OF THE DRAWINGS

The above and other aspects, features, and advantages of the present invention will be more apparent from the following, more detailed description thereof, presented in conjunction with the following drawings, wherein:

FIG. 1A is a depiction of a prior art dolly-type hand cart shown carrying two medical gas cylinders;

FIG. 1B is a depiction of a prior art means of storing medical gas cylinders by chaining the cylinders to a wall;

FIG. 2 is a perspective view of the medical gas cylinder cart in accordance with an embodiment of the present invention;

FIG. 3 is a front view of the medical gas cylinder cart of FIG. 2;

FIG. 4 is a side view of the medical gas cylinder cart of FIG. 2;

FIG. 5 is a top view of the medical gas cylinder cart of FIG. 2;

FIG. 6 is an illustration of the medical gas cylinder cart shown with a medical gas delivery device and IV pole in accordance with another embodiment of the present invention; and

FIG. 7 is an illustration of the medical gas cylinder cart of FIG. 6 shown retaining two medical gas cylinders.

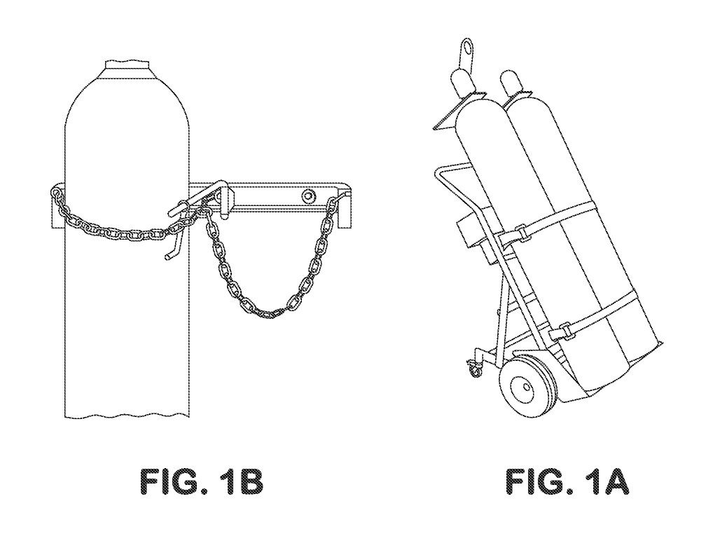

### DETAILED DESCRIPTION

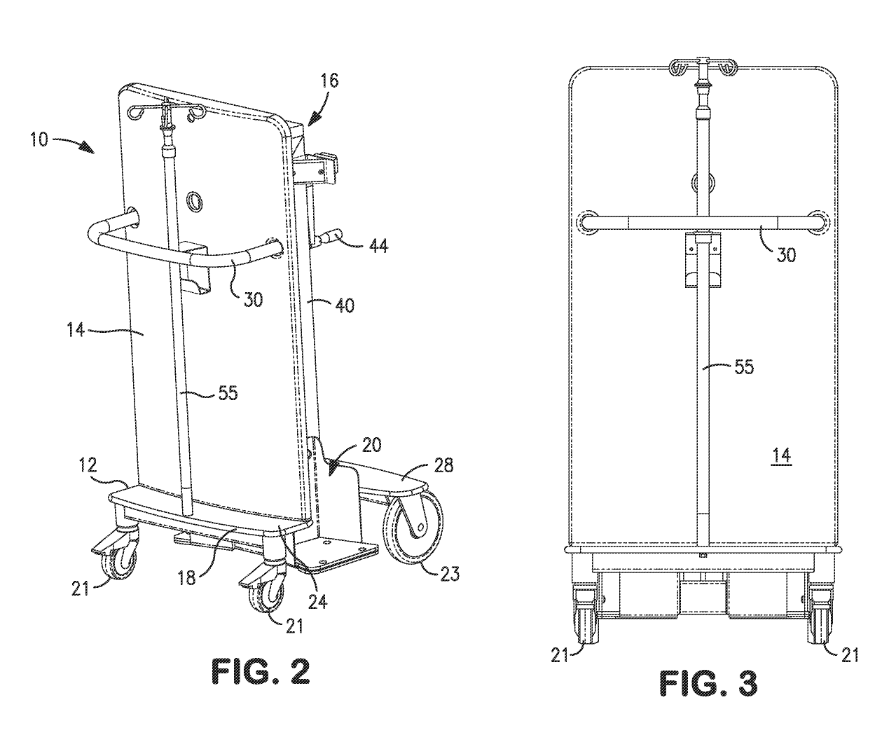

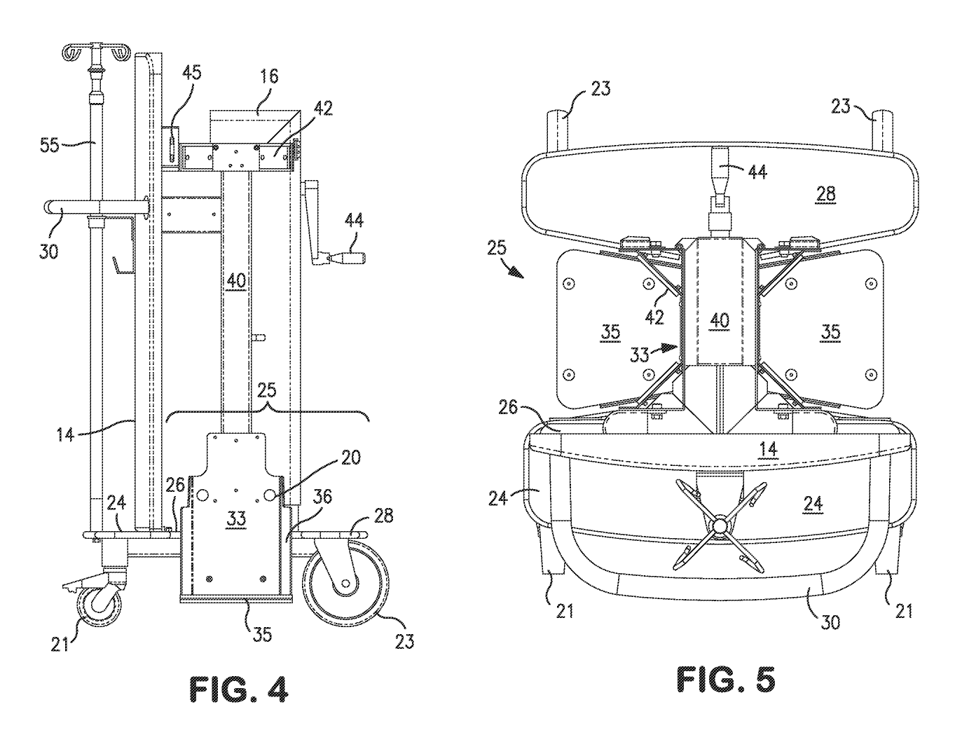

Turning now to FIGS. 2 through 5, there is seen a preferred embodiment of the present medical gas cylinder cart. The illustrated medical gas cylinder cart 10 is adapted to be used both as a cylinder storage and transportation cart as well as a stand-alone aesthetically acceptable fixture in a medical facility treatment or patient room.

The illustrated medical gas cylinder cart 10 includes a base 12; front panel 14; a main body 16; and one or more adjustable gas cylinder shelves 20. The illustrated base 12 is maintained at a prescribed clearance off the ground and is supported with a plurality of heavy duty wheels and casters shown generally as two smaller front casters 21 and two larger back wheels 23 sufficient to hold the weight of the cart with large, heavy medical gas cylinders disposed thereon. The base 12 is generally comprised of three sections including a forward section 24 and a back section 25. The illustrated back section 25 is further partitioned into a mid section 26 and an aft section 28. Note that the front casters 21 extend beyond the forward section 24 of the base 12 and the back wheels 23 preferably extend beyond the aft section 28 of the base 12 so that the casters or wheels will contact the wall or other obstructions before the base 12 to prevent accidental structural damage to the cylinder cart 10.

The front panel 14 is attached to the base 12 proximate the forward section 24 of the base 12 and extends upright from the base 12 in a manner that preferably forms a front ledge 18 on the cart 10. The finish, material and color selections of the cart, and preferably the front panel 14 and front ledge 18 are important to realize a sophisticated and elegant medical type product. The entire medical gas cylinder cart 10 and in particular, the front panel 14 of the cart 10 are designed to be aesthetically pleasing and provide cover to generally hide the appearance of the medical gas cylinders from sight, including unsightly blemishes, scrapes, rust, dings, etc. on the medical gas cylinders. In the preferred embodiment, the height of the front panel 14 is such that it allows an unobstructed view of the cylinder cap and any valve, regulator, and/or pressure gauge from the front when the cylinder is in operation to facilitate easier monitoring and use of the medical gas cylinder.

The illustrated front panel 14 is also equipped with a horizontal handle 30 adapted to allow a user to grasp the handle 30 and easily move the medical gas cylinder cart 10 to a desired location. The horizontal handle 30 is easily accessible and configured to allow the user to hang or wrap various articles on or around the handle 30 such as electrical cords, tubing, auxiliary devices, accessories, patient records, etc.

The illustrated cart also has the option of integrating a height-adjustable pole, such as an IV pole, preferably extending vertically from the front ledge 18 of the cart 10 to hold sterile water, drugs, or other medical products to be used during or in conjunction with the medical gas treatments. Alternatively, the pole can also serve as a holder of some medical equipment such as gas blending machine, humidification, or drug delivery device or combinations thereof.

Although not shown, the front panel 14 may be equipped with one or more optional through-holes to pass any needed electrical cords or communication cables from the front of the cart to the back of the cart as well as to pass any tubing/hoses from the medical gas cylinder valves/regulators to the front of the medical gas cylinder cart 10 for improved usage and access of the gas cylinders and associated devices. Alternatively, the optional through holes may be configured to align with the pressure/contents gauge of the stored medical gas cylinders so one can visually see the cylinder indications and alarms, or to allow for manual or automatic usage switch from one cylinder to the other. The front panel 14 may also include one or more drawers, storage compartments, or storage racks (not shown) to hold the hoses, accessories and/or spare parts.

The main body 16 of the cylinder cart 10 provides the structural integrity of the cart 10 and, as illustrated, is preferably attached to the base 12 proximate the mid section 26 and/or aft section 28 of the base 12. The adjustable gas cylinder shelves 20 are operatively coupled to main body 16 of the cylinder cart 10 and designed to facilitate easy loading, transportation and storage of medical gas cylinders. In the illustrated embodiment, the adjustable gas cylinder shelves 20 on the medical gas cylinder cart 10 are adapted to hold two of the largest and heaviest gas cylinders used in the healthcare industry.

Turning again to FIGS. 2 through 5, each of the adjustable gas cylinder shelves 20 includes a vertically oriented compartment 33 comprising a cylinder platform 35 and a lower bulkhead or housing 36 connected to and partially surrounding the cylinder platform 35. The cylinder platform 35 and lower bulkhead or housing 36 are adapted to receive a vertically oriented large medical gas cylinder. The vertically oriented compartment 33 also includes a lift mechanism or jack 40 adapted to lower and raise the cylinder platform 35 to and from the ground level below the base 12 of the cart 10. When the cylinder platform 35 is at ground level, the medical gas cylinders can be easily loaded or unloaded to or from the cylinder platform 35.

Each adjustable gas cylinder shelf 20 also includes an upper bracket or brace 42 used to keep the gas cylinder disposed on the platform 35 and aligned in a vertically oriented position. Once aligned, a strap 45 or similar such retainer operatively connected to the bracket or brace 42 is used to secure the medical gas cylinder in its vertical orientation.

The lift mechanism or jack 40 is used to raise the medical gas cylinder back to or above the base 12 of the medical gas cylinder cart 10 for transportation and subsequent use of the medical gas. When transporting the medical gas cylinder on the cart 10, the cylinder platform 35 should be raised to at least the level of the base 12. During use of the medical gas with a patient, the medical gas cylinder can be further raised via the lift mechanism or jack 40 to a height above the base 16 to allow an unobstructed view of the cylinder cap and any valve, regulator, and/or pressure gauge to facilitate easier monitoring and use of the cylinder. Lifting or raising the top portion of the medical gas cylinder above the height of the front panel 14 is an important consideration in the medical gas field as it is crucial for the properly trained health care provider who administers the medical gas to visually see the color and markings on the cylinder shrouds or cylinder caps so as to identify the type of medical gas in the cylinder.

In the present embodiment, the preferred lift mechanism or jack 40 uses a hydraulic cylinder actuated using a handle, crank or wheel 44 attached to the main body 16 of the cylinder cart 10 behind the front panel 14. Alternatively the lift mechanism or jack 40 can employ a mechanical, electro-mechanical, or other means for actuating and lifting the medical gas cylinders. Preferably, the lift mechanism is arranged such that the medical gas cylinders can be raised or lowered quickly and quietly from a ground position for loading and unloading cylinders, to a transport position and/or a cylinder usage position with only a limited number of turns of the handle 44 or limited effort of the hospital staff. The lift mechanism or jack allows an average healthcare worker, such as a nurse or respiratory therapist, to easily lift medical gas cylinders weighing several hundreds of pounds. The present cylinder cart 10 is preferably designed for easy use by persons of either gender and by persons of normal or extreme height ranges. Once the cylinder platform 35 is down to ground level, the gas cylinders can be moved away from the cylinder cart 10 in the typical rotating fashion used to move heavy medical gas cylinders in the healthcare industry. In the preferred embodiment, the two medical gas cylinders would be size T or size K cylinders with valves, regulators and cylinder caps and with a total weight of about 300 pounds or less.

Although the present embodiment is illustrated as employing a single lift mechanism for simultaneously lifting two adjustable gas cylinder shelves, it is possible to design a single unit medical gas cylinder cart or a multi-unit medical gas cylinder cart using two or more cylinder shelves and multiple lift mechanisms such that gas cylinders can be loaded and unloaded onto different shelves independently from one another. However, a key aspect and feature of the present embodiments is the relatively small footprint of the medical gas cylinder cart and the ease of which one can maneuver the cart in a hospital or patient setting.

As indicated above, the preferred embodiment includes a strap 45 or retaining belt proximate the upper bracket or brace 42 to securely lock the medical gas cylinders on the cylinder platform 35. Once the medical gas cylinders are locked in place, the user then actuates the lift mechanism 40 by rotating the handle/wheel 44 to lift the cylinder platform 35 up off the ground level. Preferably, a visual indicator on the back of the cylinder cart 10 near the rotating handle 44 allows the user to visually know when the cylinder platform 35 and the medical gas cylinder is in the preferred aligned elevated position. Once aligned, the locking strap or retaining belt is inaccessible or otherwise hidden by the cylinder cart 10 so that one cannot not accidentally unbuckle or release the medical gas cylinders while in an elevated position to ensure that the medical gas cylinders cannot fall from the cylinder cart 10.

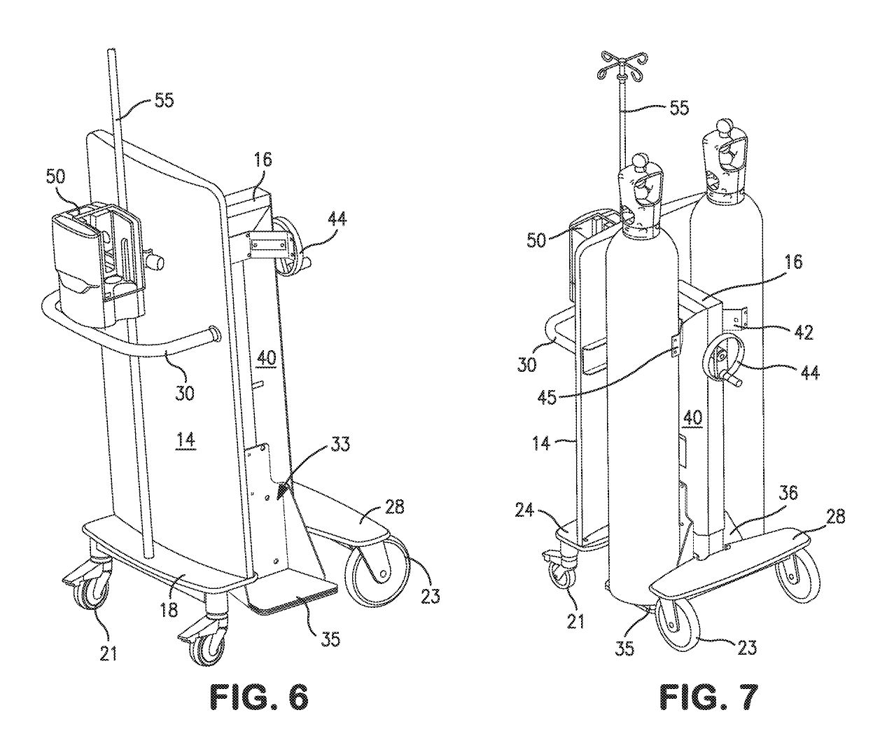

Turning now to FIGS. 6 and 7, there is shown an illustration of an embodiment of the medical gas cylinder cart 10 shown with a medical gas delivery device 50 and adjustable height IV pole 55 integrated with the cylinder cart 10. In FIG. 6, the medical gas cylinder cart 10 with the gas delivery device 50 and IV pole 55 is shown without the medical gas cylinders. The typical IV pole is a height adjustable IV pole with a diameter of about ¾″ to ¼″ and the preferred delivery device is a Precision Flow® System available from Vapotherm Inc. of Stevensville, Md. or similar gas delivery device.

This illustrated arrangement depicts the compact footprint and easy maneuverability of the medical gas cylinder cart 10 with the cylinder platforms 35 in the raised position. FIG. 7, on the other hand, shows the embodiment of the medical gas cylinder cart 10 with the medical gas delivery device 50 and with medical gas cylinders 60 just loaded onto the cylinder cart 10 wherein the cylinder platform 35 is lowered to the ground level using the handle/wheel 44. Prior to use, the user would strap the medical gas cylinders 60 in place and turn the handle/wheel 44 until the cylinder platform 35 with the medical gas cylinders 60 is raised to a level equal to the height of the base 12 for transport of the medical gas cylinders 60 or to a level above the height of the base 12 for delivery and use of the medical gas to the patient via the delivery device 50.

In the preferred embodiment, the cylinder cart may also include a common gas manifold with automatic switchover between cylinders when one of the cylinders is empty or near empty. In such embodiment, the multiple medical gas cylinders are operatively coupled to the common manifold via standard or proprietary gas couplings. Medical gas is dispensed from one cylinder to the common manifold and subsequently to the gas delivery device and on to the patient. As soon as one cylinder nears empty, the manifold automatically switches the supply of the medical gas to another gas cylinder. The empty medical gas cylinder can then be switched out without interrupting the medical gas therapy administered to the patient.

From the foregoing, it should be appreciated that the present invention thus provides a gas cylinder cart for the loading, transportation and storage of gas cylinders, such as medical gas cylinders. While the invention herein disclosed has been described by means of specific embodiments and processes associated therewith, numerous modifications and variations can be made thereto by those skilled in the art without departing from the scope of the invention as set forth in the claims or sacrificing all of its features and advantages. For example, the present cylinder cart can be adapted for the loading, transportation, storage and use of industrial gases for industrial purposes.

1. A gas cylinder cart comprising:
a base supported above ground level with wheels, casters or other moveable support structures;
a main body extending vertically from the base;
one or more adjustable gas cylinder shelves connected to the main body and adapted to hold one or more gas cylinders in a vertical upright orientation; and
a lift mechanism or jack coupled to the main body and configured to raise or lower the adjustable gas cylinder shelves to and from the ground level below the base to facilitate loading and unloading of the one or more gas cylinders onto the adjustable gas cylinder shelves.

2. The gas cylinder cart of claim 1 further comprising a front panel attached to the base or the main body, the front panel extending vertically upward from the base to partially conceal the one or more gas cylinders on the one or more adjustable gas cylinder shelves.

3. The gas cylinder cart of claim 1 wherein each of the adjustable gas cylinder shelves further comprise a cylinder platform and a cylinder housing or bulkhead structure configured to receive a gas cylinder.

4. The gas cylinder cart of claim 3 further comprising a brace or retainer configured to secure the gas cylinder to the main body and in a vertical orientation on the cylinder platform.

5. The gas cylinder cart of claim 1 wherein the lift mechanism or jack operatively moves the one or more adjustable gas cylinder shelves from a first position proximate the ground level to facilitate loading of the one or more gas cylinders onto the one or more adjustable gas cylinder shelves and a second position above the ground level to facilitate transport of the one or more gas cylinders.

6. The gas cylinder cart of claim 5 wherein the wherein the lift mechanism or jack is a hydraulic cylinder actuated using a handle, crank or wheel.

7. The gas cylinder cart of claim 1 wherein the gas cylinder is a medical gas cylinder.

8. A gas cylinder cart comprising:
a moveable base having a forward section and an back section, the base being supported above ground level with wheels, casters or other moveable support structures;
a front panel attached to the moveable base proximate the forward section of the moveable base and extends vertically upward from the moveable base;
a main body attached to the back section of the moveable base; and
one or more adjustable gas cylinder shelves connected to the main body and adapted to hold one or more gas cylinders in a vertical upright orientation behind the front panel, each of the adjustable gas cylinder shelves includes a cylinder platform and a lift mechanism or jack adapted to raise or lower the cylinder platform to and from the ground level below the base of the cart to facilitate loading and unloading of the gas cylinders onto the cylinder platform.

9. A method of transporting one or more gas cylinders, comprising the steps of:
moving a gas cylinder cart to a first location proximate one or more gas cylinders, the gas cylinder cart comprising a base substantially parallel to a ground level; a main body; one or more adjustable gas cylinder shelves connected to the main body and adapted to hold one or more gas cylinders in a vertical upright orientation; and an actuated lift mechanism or jack coupled to the main body and configured to raise or lower the adjustable gas cylinder shelves;
lowering the one or more adjustable gas cylinder shelves on the gas cylinder cart to a position proximate the ground level using the actuated lift mechanism or jack;
loading one or more gas cylinders onto the lowered adjustable gas cylinder shelves;
raising the one or more adjustable gas cylinder shelves with the gas cylinders disposed thereon to a position above ground level using the actuated lift mechanism or jack; and
transporting the gas cylinder cart with one or more gas cylinders disposed in the one or more adjustable gas cylinder shelves positioned above ground level to a second location where the one or more gas cylinders are to be used.
